(19) United States
(12) Patent Application Publication
(10) Pub. No.: US 2002/0007315 A1
(43) Pub. Date: Jan. 17, 2002

(54) Methods and apparatus for voice activated audible order system

(76) Inventor: Eric Rose, Newport Coast, CA (US)

Correspondence Address: KNOBBE MARTENS OLSON & BEAR LLP, 620 NEWPORT CENTER DRIVE, SIXTEENTH FLOOR, NEWPORT BEACH, CA, 92660, US

(21) Appl. No.: 09/836,855

(22) Filed: Apr. 16, 2001

Related U.S. Application Data
(60) Provisional application No. 60/197,097, filed on Apr. 14, 2000.

(51) Int. Cl. G06F 17/60

(52) U.S. Cl. 705/15

(57) ABSTRACT

Systems, apparatus and methods for a voice activated delivery of orders to the restaurant food preparers. Food orders from customers are entered in a point-of-sale (POS) register. The restaurant worker speaks an order which is received by a speech-to-text search, resulting in a conversion into speech of a POS entry. The restaurant worker receives an audible synthesized voice reciting the POS entry. As a result, the restaurant worker is not required to view a visual display. The preferred embodiments include wireless communication with the restaurant worker so that the worker may move freely while speaking voice commands and receiving the synthesized voice orders.

### PRIORITY CLAIM

This application claims the benefit of U.S. Provisional Application No. 60/197,097 filed Apr. 14, 2000.

### FIELD OF THE INVENTION

This invention relates to methods and apparatus for verbally communicating sale orders entered in a point-of-sale register.

### SUMMARY OF THE INVENTION

The preferred embodiment of the invention interprets voice commands from a user to parse through a memory file. The memory file is filled with quantity and order information and sent over a network in condensed fashion. A voice operated audible order module translates this information and coverts it to speech, which is in turn sent over radio frequency link to the user.

### BRIEF DESCRIPTION OF THE DRAWINGS

The invention will now be described with reference to the appended drawings which depict embodiments of aspects and features of the invention. The illustrated embodiments, however, are intended to only illustrate and not to limit the invention. The drawings contain the following figures:

FIG. 1 is a block diagram of a typical system used for communicating point-of-sale orders to the food preparer;

FIG. 2 is a block diagram of one embodiment of this invention;

FIG. 3 is a block diagram of another embodiment of this invention;

FIG. 4 is a detailed block diagram of the voice operated audible order system of FIGS. 2 and 3; and

FIG. 5 is a detailed block diagram of the memory shown in FIG. 4.

### DETAILED DESCRIPTION OF THE PREFERRED EMBODIMENTS

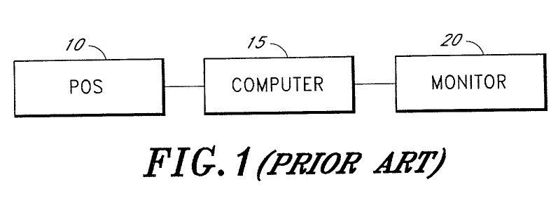

Referring to FIG. 1, a system representative of point-of-sale systems currently in use in fast food restaurants is shown. The customer's order is entered by a restaurant employee on a point-of-sale register (POS) 10. As is well known, these orders are either given face-to-face between the customer and employee or by the customer speaking into a microphone while sitting in his or her car in a drive through lane. Each order is electronically communicated to a computer 15. Computer 15 displays the order on a video monitor 20 placed in front of or above the individual or individuals in the kitchen actually preparing the order.

These prior art systems have a number of significant problems. Thus, the food preparer must repeatedly direct his or her attention from the food preparation to read the order on the monitor screen and keep track of which items he or she has already prepared and which found orders are still to be prepared. Since the monitor is mounted in fixed or “home” location, the food preparer must go back to this “home” position to get the next item off the monitor.

Another disadvantage of the FIG. 1 system is that the limited space on the monitor requires many words to be abbreviated to fit the monitor screen. Examples are displaying an order for a “Taco Supreme” as TAC SUP or displaying a customer's request for onions as +ON. These abbreviations are not obvious to a new worker and as a result, the food preparation is slowed until this worker understands all of the abbreviations.

A further disadvantage of the FIG. 1 system is that the monitor display is confusing in that it typically displays two or more orders. Information, other than that pertaining to the order in preparation, is not pertinent (except to tell the food preparer that additional orders are in the queue) and can easily confuse the food preparer and result in mistakes being made.

Thus, the typical prior art system promotes mistakes and wasted activity for the food preparer by requiring the food preparer to (a) go to the “home” position, (b) view the monitor, (c) find the last entry read, (d) interpret abbreviations, and (e) cause the order on the screen to be “bumped” or erased by pressing, for example, a button or food pedal, when the food order has been completed. The present invention eliminates these problems for the food preparer or preparers.

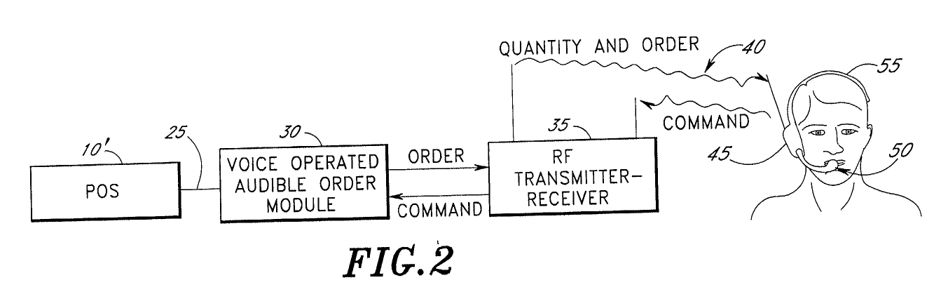

In one embodiment of the present invention shown in FIG. 2, point-of-sale orders from the customers are entered into the point-of-sale sale register 10′. The order is sent over a network 25 and stored as digital data in the voice operated audible order module 30. Module 30 is advantageously connected to a radio transmitter-receiver 35 which is connected by a suitable radio link 40 to a miniature transmitter-receiver 45 worn by the food preparer connected to a microphone 50 and headphones 55.

Voice operated audible order module 30 performs, in the preferred embodiment of this invention, the functions of (1) providing a text-to-speech synthesizer for converting the POS entries into audible speech and (2) speech recognition of voice commands from the kitchen worker. These audible menu orders and speech commands are transmitted over the wireless link 40 between the radio frequency transmitter-receiver 35 to the transmitter-receiver 45 worn by the food preparer.

By way of specific example, an order for two tacos is handled by the system of FIG. 2 as follows: the order is taken on POS 10′ by the order taker and stored in the memory of voice operated audible order module 30. Module 30 will then wait until the food preparer worker speaks the word “GO” into the microphone 50 connected to transmitter-receiver 45. This audio command message is transferred from the microphone 50 and transmitter-receiver 45 over the wireless link 40 to transmitter-receiver 35. The word “GO” is then translated by speech recognition circuitry and software in module 30 as a signal to convert the stored electronic message from POS 10′ into the audible voice message “two tacos.” These words are then transmitted back to the worker's headphones 55 connected to transmitter-receiver 45. When the worker has completed preparation of the two tacos, he or she will again say “GO” and the next item from the POS will be translated into audible speech and sent to the worker.

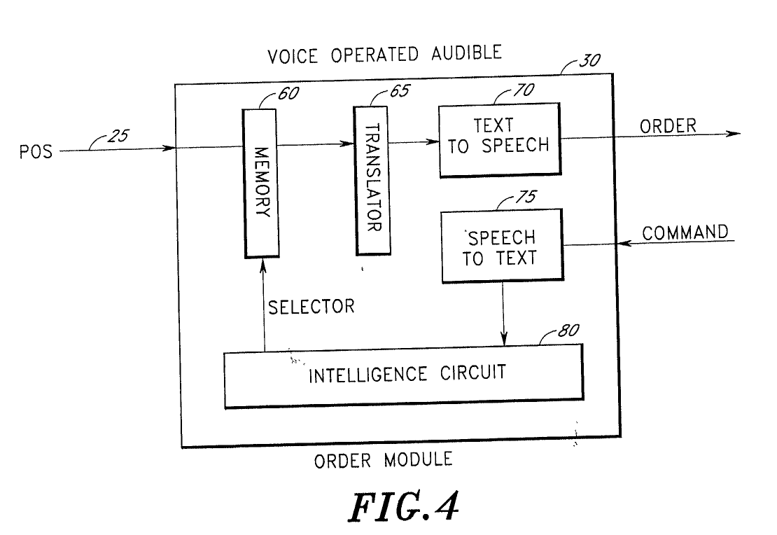

Referring to FIG. 4, in this preferred embodiment, the voice operated audible system 30 interprets voice commands (from the person preparing the food) to parse through a digital data memory file 60 storing POS orders. Module 30 includes a translator circuit 65 that converts the stored POS information into synthesized speech in text-to-speech converter 70, which in turn is sent over the radio link 40 shown in FIG. 2.

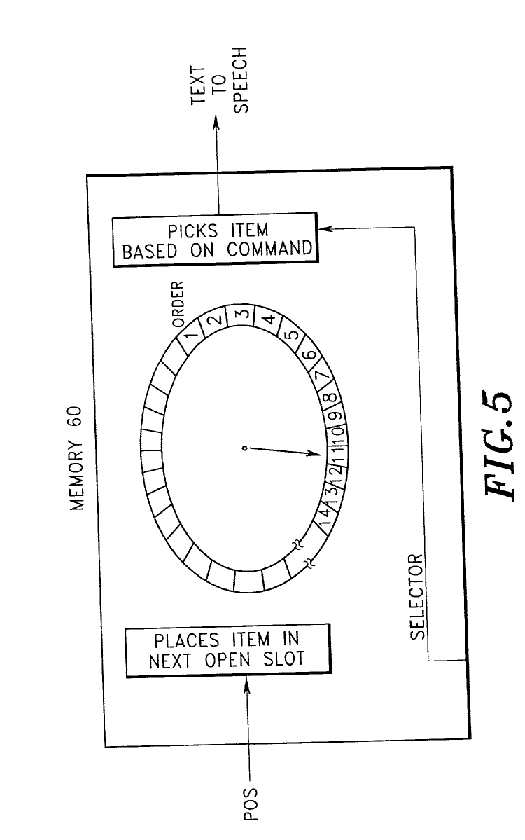

Audible speech commands or prompts from the food preparer are received via the radio link 40 and converted by the voice recognition speech-to-text circuit 75 and intelligence circuitry 80. The operator's spoken commands are thus interpreted in module 30 to produce control signals for parsing through the memory 30. Referring to FIG. 5, the intelligence circuit 80 effectively allows the food preparer-user to parse through the memory by moving a pointer to the item the user wants to hear. The item is then sent to translator 65 wherein the compressed order information (from the POS 10′ register) is expanded. The expanded information is then sent to the text-to-speech converter 70 before being transmitted to the same headset which initiated the command.

A feature of the preferred embodiment is that only a few easily learned and distinctly sounding voice commands are all that need to be recognized by the speech recognition software and circuitry in module 30 to enable the food preparer-user to enjoy total command over the system. Even only four voice commands can be sufficient to provide substantial control over the delivery of the audible order information to the food preparer, examples herein:

GO

AGAIN

BACK

NEW

or; alternatively,

GO

REPEAT

BACK

NEW

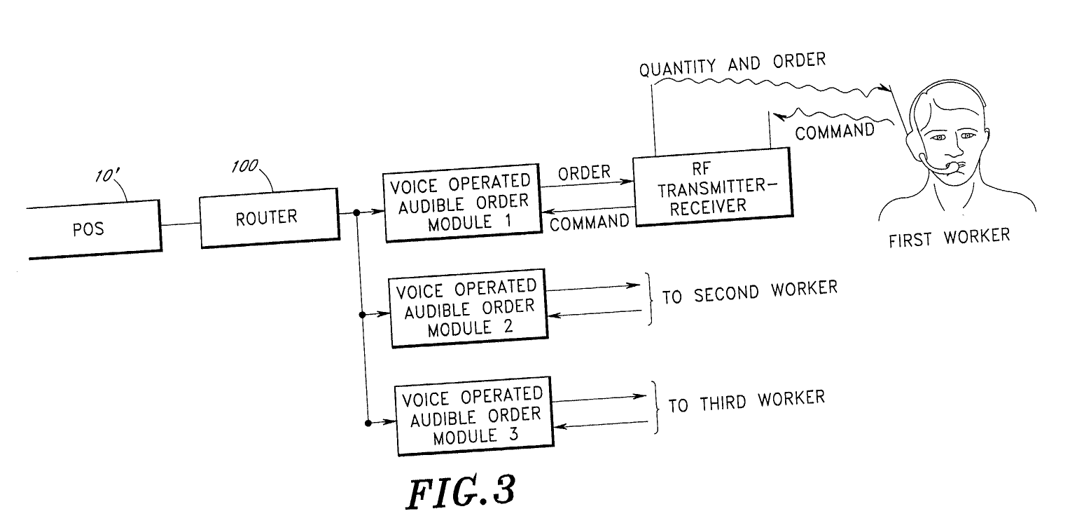

Another embodiment of the invention is shown in FIG. 3 in which the restaurant or other facility has multiple workers available to prepare the orders. In this embodiment, a router 100 routes the POS 10′ orders to one of several of the voice operated audible order modules. The routing function can be sequential, or can be responsive to the number of orders stored in each memory, with the module having the fewest entries having priority to receive the next order.

A sample order A using the system of FIG. 2 will now be described. It will be understood that this example is provided to further describe the overall function of the system. However, the specific order and times specified, e.g., 30 second gap and five second repeat are advantageously selectively variable depending upon the specific time demands for filling orders.

### Sample Order A

If the GO command is not received within 30 seconds, the system will prompt the user with “Order Waiting”. This will repeat every 5 seconds until a command is given by the User.

The user will prompt the next menu item with “Go”

The voice operated audible order module 30 will read only one menu item block in memory 60 at a time. For example, a customer entry in the point-of-sale register 10 is “3 Tacos”, or “Special, 1 Bean Burrito, no onions”

Menu items with modifiers such as “Bean Burrito, no onions” will be preceded with the word “Special”.

When no further items are in the queue, the module 30 will follow a prompt of “Go” with “Done”.

If the User needs to hear the last order again, he or she will say “Again” or “Repeat”

If the User wants to hear previous orders back up the menu stream, the User will say “Back”. Each incidence of “Back” will cause the computer to say the previous menu item.

The module 30 will precede any repeated or previous order with the word “Repeat”.

The User can start at the next order by saying “New”

Example, (no order for 30 seconds), customer places order of 2 Tacos and a Taco Salad without beef, User hears “New Order”.

User says “Go”.

The module 30 says, “2 Tacos”.

User makes two tacos and says “Go”, computer says “1 Taco Salad Special, no beef”, user says “Go”,

The module 30 says “Done” (no more orders in the queue).

Another feature of the invention is that certain orders entered at the POS register can be automatically diverted. For example, drink orders are often handled by the order taker and not by another food preparer. In this case, the drink order entry is blocked by the order module 30 and not translated into speech. An example of this method is included in the sample order B below.

### Sample Order B

Example, a customer entry in the point-of-sale register 10′ is 2 Tacos, 1 with extra cheese, a bean burrito with sour cream on the side and a Pepsi.

User says “Go”.

Computer says “1 Taco”,

User says “Go”.

Computer says “1 Taco Special, extra cheese” (this may also be combined to “2 Tacos Special, 1 with extra cheese”).

User wants to hear the first Taco order again and says “Back”,

computer says “Last item, 1 Taco Special, extra cheese”,

User says “Back” again

Computer says “Back 1 item, 1 Taco”.

User says “Go”, (User could also reset to next item with “New”) computer says, “Last Item, 1 Taco Special, extra cheese”

User says “Go”,

Computer says “1 Bean Burrito”,

User says “Go”,

Computer says “1 side of Sour Cream”,

User wants to hear this again and says “Repeat”. (“Back” or “Again” will get the same response for the last item)

Computer says “Repeat, 1 side of Sour Cream”.

User says “Go”

Computer then continues with next item in the queue for the next customer.

Note that in Sample Order B, the Pepsi drink entered into this POS register 10′ is not delivered to the food preparer.

What is claimed is:

1. A voice activated audible order system for a fast food restaurant, wherein the restaurant food preparer worker does not receive food orders from a visual display, comprising:
a point-of-sale (POS) register in which food orders are entered;
a plurality of voice operated audible order modules, each module including:
a memory for storing a POS entry,
a text-to-speech synthesizer for converting the POS entries into audible speech, and
a speech-to-text circuit for recognizing and converting voice commands into control signals;
a router connected between said POS register and said voice operated audible order modules for selectively routing said POS register to a particular one of said modules;
a plurality of sets of microphones and headphones; and
a wireless link respectively coupling said plurality of microphone and headphone sets to one of said voice operated audible order modules, whereby a restaurant worker speaks an audible command into a microphone and receives on headphones an audible synthesized voice reciting an order entered into said POS register without the worker having to view any visual display.

2. A voice activated audible order system for a fast food restaurant, wherein the restaurant food preparer worker does not receive food orders from a visual display, comprising:
a point-of-sale (POS) register in which food orders are entered;
a voice operated audible order module coupled to said POS register, said module including:
a memory for storing a POS order,
a text-to-speech synthesizer for converting the POS entries into audible speech, and
a speech-to-text circuit for recognizing and converting voice commands into control signals;
a microphone and headphone,
a wireless link coupling said microphone and headphone to said voice operated audible order module, whereby a restaurant worker speaks an audible command into said microphone and receives on said headphone an audible synthesized voice reciting an order entered into said POS register without having to view any visual display.

3. A voice activated audible order system for a fast food restaurant, wherein the restaurant food preparer worker does not receive food orders from a visual display, comprising:
a point-of-sale (POS) register;
a voice operated audible order modules coupled to said POS register, said module including:
a memory,
a text-to-speech synthesizer coupled to said memory, and
a speech-to-text circuit;
a microphone and headphone; and
a wireless link respectively coupling said microphone to the input of said speech-to-text circuit and said headphone to the output of said text-to-speech synthesizer.

4. The voice activated audible order system of claim 3, wherein said voice operated audible order module includes an intelligence circuit coupled to said memory, said intelligence circuit responsive to spoken commands to go back to a previous stored order or to advance to a subsequently stored order.

5. A voice activated order systems comprising:
a point-of-sale register;
a computer memory coupled to said point-of-sale register and storing a plurality of orders entered into said point-of-sale register;
a speech recognition circuit responsive to audible commands spoken into a microphone and operatively coupled to said memory;
a speech synthesizer coupled to said memory for converting a stored order into speech when a predetermined command is spoken into said microphone; and
a set of headphones or the like connected to said speech synthesizer.

6. The voice activated order system of claim 5, wherein a radio link connects to said microphone and said headphones respectively to said speech recognition circuit and said speech synthesizer.

7. A voice activated order method for a fast food restaurant in which the food preparer worker does not receive food orders from a visual display comprising:
entering food orders into a point-of-sale (POS) register;
temporarily storing as digital data said entered food orders;
said food preparer worker speaking an audible command into a microphone;
recognizing said command to connect said command into a control signal; and
using said control signal to initiate converting stored digital data relating to a food order into synthesized speech audibly transmitted to said food preparer.

8. The method of claim 7, including automatically diverting certain orders so that all POS entries are not ultimately received by a single food preparer worker but or instead filled by at least one other worker.

9. The method of claim 8, including automatically routing each of said food orders to a selected one of a plurality of temporary data storage memories.

10. A voice activated order method comprising:
storing a plurality of orders in a computer memory;
recognizing an audible command; and
causing a stored order in said computer memory to be supplied to a speech synthesizer.

11. The method of claim 10, wherein said audible commands include short one-syllable words, such as GO, AGAIN, BACK, NEW.
